(19) United States
(12) Patent Application Publication
(10) Pub. No.: US 2005/0138486 A1
(43) Pub. Date: Jun. 23, 2005

(54) System and method for pre-searching error messages

(75) Inventor: Tatjana Gromyko, Edingen-Neckarhausen (DE)

Correspondence Address: KENYON & KENYON, 1500 K STREET, N.W., SUITE 700, WASHINGTON, DC, 20005, US

(73) Assignee: SAP Aktiengesellschaft

(21) Appl. No.: 10/743,286

(22) Filed: Dec. 23, 2003

(51) Int. Cl. G06F 11/00

(52) U.S. Cl. 714/49

(57) ABSTRACT

A system and method for pre-searching a solution database to find potential solutions to customer-generated error reports. An error report received from a customer is parsed to extract keywords pertaining to the subject matter of the reported error. The extracted keywords are then arranged into a query, which is submitted to a solutions database. Solutions obtained from the solutions database in response to the query are sorted and formatted for display to a customer service representative, who can then study the displayed solutions to determine how to respond to the customer submitting the error report.

### TECHNICAL FIELD

This invention relates generally to message processing. More particularly, the invention relates to methods and systems for improving the efficiency of responding to customer-generated error messages.

### BACKGROUND OF THE INVENTION

Computer software is almost never free of errors. Even after software programs have undergone long hours of extensive alpha testing (by the software developer) and beta testing (by selected customers), errors and design shortcomings may still remain. To respond to customer reports of discovered errors and design oversights, many software manufacturers establish dedicated customer service facilities. These facilities, sometimes referred to as “help desks” or “call centers,” receive, catalog and respond to customer reports of errors discovered or perceived to exist in delivered software products.

Help desks are labor intensive efforts. Knowledgeable support analysts typically review error reports as they arrive in order to understand the subject matter and the content of the report. Based on that review, the support analyst may then search databases containing solutions that were developed to address previously reported errors. If a solution is found in one of the databases, the support analyst may send that solution to the customer who reported the error. Otherwise, the analysis will usually forward the error report to an appropriate engineering group for further study.

Most of the time, between 60 and 90 percent of the errors reported by customers have been solved before. For these solved errors, no new engineering is required. Instead, a support analyst need only locate the appropriate solution and send it to the customer. Currently, customer support analysts spend significant amounts of time searching solution databases to discover potential solutions to reported errors. Efforts to reduce the search time required to locate possible solutions to known errors, as well as to identify those reported errors for which no known solution yet exists, will significantly improve customer response times and will lower the costs necessary to provide customer support services.

Accordingly, there is a need in the art for a system and method for pre-searching solution databases based on the content of customer-provided error reports.

### SUMMARY OF THE INVENTION

Embodiments of the present invention are directed to a system and method for pre-searching a solution database to find potential solutions to customer-generated error reports. An error report received from a customer is parsed to extract keywords pertaining to the subject matter of the reported error. The extracted keywords are then arranged into a query, which is submitted to a solutions database. Solutions obtained from the solutions database in response to the query are sorted and formatted for display to a customer service representative, who can then study the displayed solutions to determine how to respond to the customer submitting the error report.

### BRIEF DESCRIPTION OF THE DRAWINGS

FIG. 1 is a high-level block diagram of a computer system incorporating a method and system for pre-searching customer-generated error reports in accordance with an embodiment of the present invention.

FIG. 2 is a flow chart illustrating a method for pre-searching a solution database to find potential solutions to a customer-generated error report, according to an embodiment of the present invention.

### DETAILED DESCRIPTION

Embodiments of the present invention will be described with reference to the accompanying drawings, wherein like parts are designated by like reference numerals throughout, and wherein the leftmost digit of each reference number refers to the drawing number of the figure in which the referenced part first appears.

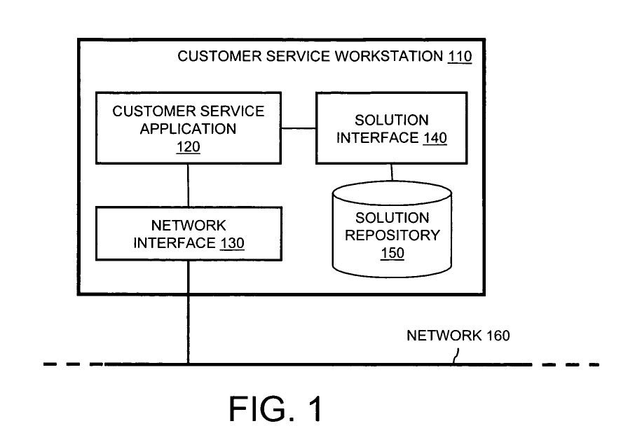

FIG. 1 is a high-level block diagram of a computer system incorporating a method and system for pre-searching customer-generated error reports in accordance with an embodiment of the present invention. As shown in FIG. 1, customer service workstation 110 may be a computer having a processor and a memory configured to enable a customer support analyst to receive and respond to customer-generated error reports. To assist the customer support analyst, customer service workstation 110 may include customer service application 120, which receives customer error reports, searches for potential solutions that match keywords extracted from the error reports, and displays the potential solutions on customer service workstation 110 for review by the support analyst. According to an embodiment, customer service application 120 communicates with network interface 130 to receive error reports from customer computers via network 160. Network interface 130 may include specific software methods and objects that enforce a desired error reporting protocol. Additionally, customer service application 120 interacts with solution repository 150 via solution interface 140. Solution repository 150 is a database of known and/or developed solutions corresponding to previously reported errors. Solution repository 150 may also contain reports of errors for which no solution has yet been developed or discovered. Solution interface 140 may comprise a traditional database management system interface using, for example SQL as a means of interacting with solution repository 150. Alternatively, solution interface 140 may comprise a library of customized knowledge mining modules capable of interacting with solution repository 150 using information mining methods known in the art.

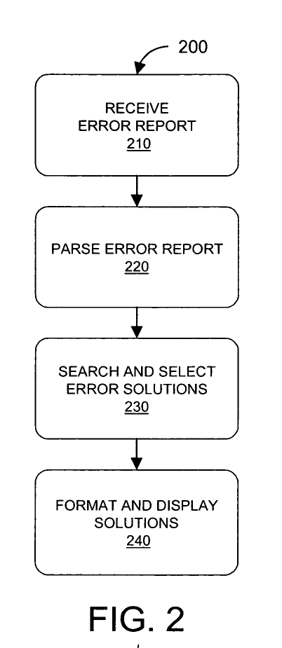

FIG. 2 is a flow chart illustrating a method 200 for pre-searching a solution database to find potential solutions to a customer-generated error report, according to an embodiment of the present invention. Method 200 initially receives an error report from a customer (210). Error reports may comprise nothing more than text messages describing a particular problem observed by a customer. On the other hand, error reports may be structured data messages containing a variety of well-defined fields. For example, according to an embodiment, an error report may contain software component attribute fields, a summary field, a separate text field, sender information, priority information, and other administrative information. Software component attributes may identify the specific software module(s) thought by the customer to be malfunctioning. Additionally, software component attributes may identify information about the operating system on which a malfunctioning software module may have been installed, as well as other related software product information, such as database management system(s) being used, version update information, software module release information, and third-party software information.

An error report may include a summary field, which may provide a short keyword-rich description of the reported error. For example, if an error report relates to a customer's suspicion that Macaulay Duration is not being calculated correctly (a Macaulay Duration is the weighted-average term-to-maturity value of a bond's cash flows, where the weighting is based on the present value of each cash flow divided by the price), the summary field may simply include the phrase “Macaulay Duration,” while the general text field may describe details of the observed error.

Error reports may also include sender information, priority information, and other administrative information. Sender information may correspond to the customer, providing company name and contact information. Priority may indicate the importance of receiving a solution, as perceived by the customer/sender. Administrative information may include such facts as the language in which the error report was written and the time the error report was submitted.

Continuing to refer to FIG. 2, when an error report has been received (210), an embodiment of the present invention may then parse the error report to extract important keywords identifying the subject matter of the error (220). To extract significant keywords that will enable a search engine to return the most appropriate solutions, method 200 may parse keywords from a summary field of the error report. Alternatively, method 200 may parse keywords from the general text field. If keywords are extracted from the general text field, the keywords may also be filtered to identify those keywords most likely to result in a match between the reported error and a known solution.

Once the appropriate keywords have been extracted from the error report, the keywords are used to search one or more databases of solutions (230). A database query may be constructed in which the appropriate tables in a database of known solutions are searched to discover those entries which match the supplied keywords. When those matching records are returned from the solutions database(s), the received solutions may be formatted and displayed for review, analysis and selection by a customer support analyst (240).

An error solutions database may be constructed according to a variety of methods known in the art. For example, solutions may be stored in a database as records containing free-form text. Alternatively, solutions may be stored in a more structured manner, according to various fields that may correspond to the different categories of information, as well as different software component attributes. According to one embodiment, the solutions database may comprise two tables for describing solutions to a reported error. One table may contain messages corresponding to the various keywords that may be used to describe an error. Another table may be restricted to notes describing the manner in which a solution to the error may be installed and/or implemented. An embodiment of the present invention may use the extracted keywords to search one or more tables in a solutions database.

When solutions are formatted and displayed for review by a customer support analyst, an embodiment of the present invention may sort the solutions according to an identified sort preference. The sort preference may be set to a default value, may be set by the customer support analyst, or may be responsive to the type of error received and/or the solutions being displayed. For example, one sort preference may sort solutions according to the number of different search keywords found in each solution returned from the solutions database(s). Another sort preference may sort solutions according to the number of times the search keywords appear in each returned solution. Yet another sort preference may sort solutions according a popularity value; that is, the number of times each returned solution has been returned as a possible solution to other previously identified errors.

When sorted solutions are displayed for review, an embodiment may partition the displayed information according to the structure of the database tables from which the information was retrieved (240). Thus, a display of potential solutions may comprise many rows of potential solutions, where each row includes several different columns corresponding to different categories of information. One category may be the solution notes derived from the notes table in the solutions database(s). Another displayed category may include the software components relevant to each solution. Yet another category may include software component release information or solution popularity and sort statistics.

Several embodiments of the present invention are specifically illustrated and described herein. However, it will be appreciated that modifications and variations of the present invention are covered by the above teachings and within the purview of the appended claims without departing from the spirit and intended scope of the invention.

1. A method for pre-searching error solutions, comprising:
parsing a customer-generated error report to extract a plurality of keywords;
assembling a query using the attributes and the keywords as selection criteria;
submitting the query to a software solution database;
collecting solutions returned from the software solution database in response to the submitted query;
sorting the collected solutions based on a sort preference; and
formatting the sorted solutions for display.

2. The method of claim 1, wherein said error report is received over a network from a customer.

3. The method of claim 1, wherein said error report includes a plurality of software component attributes.

4. The method of claim 1, wherein the error report contains an error summary field that is parsed to extract the plurality of keywords.

5. The method of claim 1, wherein the sort preference is the number of keywords found in each solution.

6. The method of claim 1, wherein the sort preference is a popularity value of each solution, said popularity value indicating number of times a solution has been returned from the software solution database.

7. The method of claim 1, wherein the query is directed to a message table and a notes table within the software solution database.

8. The method of claim 7, wherein the solutions comprise messages obtained from the message table and notes obtained from the notes table.

9. A machine-readable medium having stored thereon a plurality of instructions for pre-searching error solutions, the plurality of instructions comprising instructions to:
receive over a network a customer-generated error report including a plurality of software component attributes;
parse the error report to extract a plurality of keywords;
assemble a query using the attributes and the keywords as selection criteria;
submit the query to a software solution database;
collect solutions returned from the software solution database in response to the submitted query;
sort the collected solutions based on a sort preference; and
format the sorted solutions for display.

10. The machine-readable medium of claim 9, wherein the error report contains an error summary field and the plurality of instructions comprise instructions to parse the summary field to extract the plurality of keywords.

11. The machine-readable medium of claim 9, wherein the sort preference is the number of keywords found in each solution.

12. The machine-readable medium of claim 9, wherein the plurality of instructions comprise instructions to direct the query to a message table and a notes table within the software solution database.

13. A computer system, including:
a processor coupled to a network;
a solutions storage repository coupled to the processor;
a memory coupled to the processor the memory containing a plurality of instructions to implement a method for pre-searching error solutions, the method comprising:
parsing a customer-generated error report to extract a plurality of keywords;
assembling a query using the attributes and the keywords as selection criteria;
submitting the query to a software solution database;
collecting solutions returned from the software solution database in response to the submitted query;
sorting the collected solutions based on a sort preference; and
formatting the sorted solutions for display.

14. The computer system of claim 13, wherein said error report is received over a network from a customer.

15. The computer system of claim 13, wherein said error report includes a plurality of software component attributes.
